(19) United States
(12) Patent Application Publication
(10) Pub. No.: US 2003/0010254 A1
(43) Pub. Date: Jan. 16, 2003

(54) ADMIXTURES FOR MINERAL BINDERS BASED ON (OXIDISED) SUGAR AND HYDROGENATED SUGAR, ADMIXTURE-CONTAINING MINERAL BINDERS, AND A PROCESS FOR THE PREPARATION THEREOF

(76) Inventors: LEON MENTINK, LILLE (FR); JEAN-PIERRE GRAUX, LILLERS (FR)

Correspondence Address: HENDERSON & STURM LLP, 1213 MIDLAND BUILDING, 206 SIXTH AVENUE, DES MOINES, IA, 50309-4076, US

(21) Appl. No.: 09/247,439

(22) Filed: Feb. 10, 1999

(30) Foreign Application Priority Data
Feb. 11, 1998 (FR) 98 01643

(51) Int. Cl. C08L 1/20

(52) U.S. Cl. 106/170.41

(57) ABSTRACT

The invention relates to a novel admixture for mineral binders, composed of a composition containing at the same time a sugar or an oxidized sugar and a hydrogenated sugar.

The oxidized sugar may consist, in particular, of gluconic acid or one of its salts or an oxidized starch hydrolysate.

The hydrogenated sugar may consist in particular of maltitol, sorbitol, mannitol, xylitol, arabitol, or a hydrogenated starch hydrolysate containing at least 40% by weight of maltitol.

Within the admixture, this composition may be combined with conventional admixtures such as phosphates, borates, or amines.

The combination of a sugar or an oxidized sugar and a hydrogenated sugar within this composition makes it possible to obtain synergistic effects, particularly in terms of plasticity and mechanical properties of the mineral binders.

The admixtures claimed may be used equally well for admixing with cements, raw materials for cements as for admixing with mortars, slurries and concretes.

They may also be used in other sectors such as, for example, the plaster industry, particularly as complexing agents or hydration or dehydration controllers.

### FIELD OF THE INVENTION

The present invention relates to admixtures for mineral binders based on at least one sugar or one oxidised sugar and at least one hydrogenated sugar. It also relates to admixture-containing mineral binders and to a process for the preparation thereof.

### BACKGROUND OF THE INVENTION

The term “mineral binder” means any hydraulic binder, notably any mineral powder, capable of forming with water a paste which sets and hardens gradually, even away from the air. Conventionally, at ambient temperature, a mineral binder starts to form such a paste with water within a period of about a few minutes to less than 48 hours, generally between about 30 minutes and 24 hours. This definition applies, inter alia, to cements, natural or artificial hydraulic limes, mixtures such as mortars, slurries, coatings and concretes based on ground cement and/or lime, water and/or aggregates (sands, gravels, crushed stone . . . ), the raw materials used in the production of cements such as pozzolanas, clinkers, slags, calcareous fillers and silica fume. The term “mineral binder” also means any non-hydraulic binder based on calcium sulphate, gypsum and/or lime.

Depending on their final use and conditions of use, it is sometimes necessary to add admixtures to the mineral binders, such as grinding agents or grinding auxiliaries, plasticisers, water-reducing plasticisers and superplasticisers. These admixtures make it possible, for example, to modify the workability, setting, hardening, strength, durability and/or certain other properties of the mineral binder.

Numerous water-reducing plasticiser products or superplasticisers are already in use, including:

molasses which are relatively inexpensive products capable of fermenting and with limited effectiveness;

raw lignosulphonates which are relatively inexpensive but bring about foaming of the mortars or concretes, thus reducing their strength at 28 days;

sugars which are good water-reducing plasticisers but strong retarders;

oxidised sugars which are very good water-reducing plasticisers, retarders and which also make it possible to improve the strength at 28 days as described in the patents FR 2 387 194 and in GB 1 508 761;

sulphonated condensates of naphthalene formaldehyde or sulfonated condensates of melamine formaldehyde which are very good plasticisers, weak retarders but which do not improve the strength at 28 days and are rather unacceptable environmentally;

polyacrylates which are superplasticisers, weak retarders but which bring about little or no improvement in the strength at 28 days;

hydrogenated sugars which are water-reducing plasticisers as described in the patent FR 2 726 550 but which have a markedly weaker retarding effect than oxidised sugars whilst improving the strength at 28 days, as follows from the American patent U.S. Pat. No. 4,073,658; hydrogenated sugar syrups are also described as grinding agents, as are oxidised glucose syrups, according to the patent EP 0 695 557;

copolymers of styrene and maleic anhydride which are both superplasticisers and grinding agents as follows from the patent FR 2 744 714.

At present, for the preparation of cements, the trend is to use products that are less expensive than clinker. However, clinker confers good strength at 28 days. There is a need, therefore, for an admixture capable of correcting the strength at 28 days of cements containing little or no clinker.

Moreover, with regard to mortars, slurries and concretes, industry is seeking plasticisers and water-reducing agents or superplasticisers which are ecologically acceptable and which at the same time confer very good plasticity with little retardation, an early strength i.e. at between 8 and 24 hours, sufficient to allow rapid dismantling of the formwork, and improved strength at 28 days, if possible.

Sugars (oxidised, hydrogenated) are biodegradable products derived from renewable materials. However, they have a certain number of disadvantages.

Sugars (oxidised) generally confer strong retarding effects giving rise to extremely low early mechanical strengths which do not normally permit dismantling of the formwork of the mineral binder. Hydrogenated sugars, which have weaker plasticising and retarding effects, are highly sensitive to the nature and composition of the mineral binders. Their effectiveness depends notably on the nature and composition of the cement used. It is often necessary, therefore, to readjust their dosages from one preparation of mineral binder to the other. Moreover, and as the Applicants have found, a hydrogenated sugar such as sorbitol gives rise to “false set” phenomena.

Moreover, sugars and hydrogenated sugars act in certain cases as viscosity modifying agents as follows from patent application WO 97/27152.

There is a need, therefore, for an ecologically acceptable admixture which makes it possible to obtain a good compromise between retardation, plasticity, early mechanical strength and mechanical strength at 28 days.

Within the scope of the present invention, the term plasticity of the mineral binder means the ability to obtain a Theological state in which the mineral binder is workable, flowable or pumpable. The plasticity is measured according to the standardised method CEN 196-01 by which the spreading of a given volume of mineral binder over a vibrating table is measured in mm.

The initial set and final set are measured by means of an automatic setometer with the brand name “ACMEL”. The early mechanical strength is measured on a specimen of mineral binder according to the standard CEN 196-01 mentioned above, 17 or 24 hours after the production of the specimen. This early mechanical strength must generally be more than 5 MPa to allow dismantling of formwork. Moreover, the strength at 48 hours, 14 or 28 days of mineral binders is also measured according to the above-mentioned standard CEN 196-01.

After numerous searches, the Applicants discovered, to their merit, that an admixture meeting the above-mentioned requirements of the present art could consist in a particular composition containing selected percentages of, respectively, at least one sugar or one oxidised sugar and at least one hydrogenated sugar.

### OBJECT AND SUMMARY OF THE INVENTION

The present invention relates, therefore, to an admixture for mineral binders characterised in that it comprises a composition containing:

(A) 1 to 99%, preferably 3 to 75% and even more preferably 5 to 60% by weight of a sugar or an oxidised sugar, and

(B) 99% to 1%, preferably 97 to 25% and even more preferably 95 to 40% by weight of a hydrogenated sugar, these percentages being expressed in dry weight with respect to the total weight of sugar or oxidised sugar and hydrogenated sugar contained in the said composition.

In particular it was observed, surprisingly and unexpectedly, that by substituting a part of the sugar (oxidised) by a hydrogenated sugar it was possible to reduce the retardation and thus to increase the early strength, in a much more consistent manner than could have been anticipated by taking into account the respective quantities of sugar (oxidised) and hydrogenated sugar contained in the admixture. Synergistic effects could also be revealed for the strengths at 48 hours, 14 days and/or 28 days.

This is all the more surprising in that completely opposite synergistic effects were described in the patent FR 2 568 245 between, on the one hand, an oxidised sugar such as gluconic acid and on the other hand a hydrogenated sugar such as sorbitol. Example 1 and FIG. 1 of the said patent show that, in a particular composition, namely a rust-preventing composition based on Portland cement, latex, gluconic acid and sorbitol used as a dipping bath for steel reinforcements intended for reinforcing concrete, the combination of oxidised sugar and hydrogenated sugar creates a synergistic effect in terms of increasing the retardation. This effect is, moreover, so great that the said composition does not set even after 12 days and may be reused in the form of a bath for an indefinite period (from 2 to 110 days). It follows that such a composition which remains liquid indefinitely at ambient temperature cannot be termed a “mineral binder” within the meaning of the present invention.

There was nothing, therefore, that would lead one to suspect the synergistic effects revealed by the Applicants between (oxidised) sugar and hydrogenated sugar.

Within the scope of the present invention, the term “sugar” means, in particular, linear, cyclic or branched monosaccharides, disaccharides, trisaccharides, oligosaccharides and polysaccharides, as well as mixtures of said products such as hydrolysates of starch or inulin. Advantageously, the sugar is chosen from the group comprising glucose, fructose, xylose, arabinose, lactose, maltose, maltotriose, dextrins, starch hydrolysates, these latter being preferred, and any mixtures of said products. The sugar may be in the solid, crystalline or non crystalline, pasty or liquid form. The dry solids of these forms of presentation do not constitute a limiting parameter within the scope of the invention.

The term “oxidised sugar” means, in particular, all the products resulting from the at least partial oxidation, in whatever manner, in one or more steps, in one or more places, of the above-mentioned sugars. They are, in particular, the oxidation products of glucose, xylose, arabinose, lactose, maltose, maltotriose, starch hydrolysates, and any mixtures of these sugars.

The term “oxidation product of a sugar” means all the monoacids and polyacids capable of being obtained from a sugar (for example, gluconic, 2-ketogluconic, glucaric and glucuronic acids obtained from glucose, maltobionic acid obtained from maltose) as well as the corresponding salts of said acids, including in particular alkali metal and alkaline earth metal salts. The term “oxidised sugar” within the meaning of the present invention also means the derivatives of the above-mentioned products such as erythorbic, methyl 2-ketogluconic and ascorbic acids and the corresponding salts thereof.

The oxidation of a sugar may be carried out according to the variants described in patents EP 232 202, EP 233 816, WO 97/20860, FR 2 742 755 and EP 780 399 in the name of the Applicants. The oxidised sugar is chosen preferably from the group comprising gluconic acid, glucaric acid, xylonic acid, arabinonic acid, lactobionic acid, maltobionic acid, erythorbic acid, oxidised starch hydrolysates, the respective salts thereof, and any mixtures of said products.

Within the scope of the present invention, the term “hydrogenated sugar” means in particular all the products resulting from the reduction, in whatever manner, of the sugars and oxidised sugars mentioned above. Preferably, the hydrogenated sugar is chosen from the group comprising sorbitol, mannitol, xylitol, arabitol, iditol, maltitol, lactitol, glucosido-1,6 mannitol, isomaltitol, palatinitol, erythritol, maltotriitol, hydrogenated starch hydrolysates, hydrogenated dextrins and any mixtures of said products. The term “hydrogenated sugar” within the meaning of the present invention also means derivatives of the above-mentioned hydrogenated sugars such as derivatives containing borate such as, for example, the BOROSORB® syrups containing borate, sold by the Applicants.

Advantageously, the hydrogenated sugar is chosen from the group comprising sorbitol, mannitol, xylitol, arabitol, maltitol, lactitol, maltotriitol, hydrogenated starch hydrolysates, and any mixtures of said products. The compositions containing at least 40% by weight (dry/dry) of maltitol or lactitol are, by way of example, particularly efficient in combination with (oxidised) sugars. The admixture according to the invention may be composed entirely of the composition based on (oxidised) sugar and hydrogenated sugar described above or it may contain, apart from said composition, at least one conventional admixture for mineral binders.

Conventional admixtures such as amines, particularly triethanolamine, borates, sulphates, phosphates and calcium salts may be introduced in any proportions in the admixture according to the invention, but preferably in a quantity of 0.1 to 20%, this percentage being expressed in dry weight with respect to the dry weight of the composition based on (oxidised) sugar and hydrogenated sugar contained in the said admixture. Percentages between 0.5 and 15%, particularly between 1 to 10% are particularly advantageous.

Conventional admixtures such as derivatives of sulphonated naphthalenes or sulphonated melamines, polyacrylates, lignosulphonates, polyols other than hydrogenated sugars such as glycerol and glycols may be introduced in the admixture in any proportions, preferably in a quantity of 1 to 50%.

The Applicants found, in particular, that the concomitant use of certain conventional admixtures made it possible to obtain synergistic effects in terms of plasticity and mechanical properties.

The admixture according to the invention may itself be in the liquid, pasty or solid form. It is entirely suitable for use as an admixture for cement before, during and/or after grinding, as described for example in the above-mentioned patent FR 2 744 714, or as an admixture for hydraulic limes. It is also entirely suitable for use as an admixture for concretes, slurries and mortars, whether they be liquid or solid.

The level of introduction of the admixture according to the invention is, in practice, between 0.001 and 5% expressed in dry weight of admixture with respect to the total dry weight of raw material(s) for cement, cement, and/or lime contained in the mineral binder.

The invention also provides a mineral binder, characterised in that:

it is chosen from cements, raw materials for the production of cements, hydraulic limes and mixtures thereof, and

in that it contains 0.001 to 1.3% by weight, preferably 0.005 to 0.7% by weight and even more preferably 0.01 to 0.5% by weight of an admixture as claimed, this percentage being expressed in dry/dry as described above.

According to another variant, the invention relates to a mineral binder, characterised in that:

it is chosen from liquid, pasty or solid mortars, slurries and concretes, and

in that it contains 0.005 to 5% by weight, preferably 0.01 to 2% by weight and even more preferably 0.02 to 1% by weight of an admixture as claimed, this percentage being expressed in dry/dry as described above.

The admixture according to the invention may be introduced into the mineral binders in a great number of ways. It may, for example, be introduced in its entirety during a particular stage of production, storage, admixing, hydration, transport or placing of the mineral binder, or partially during several of these particular stages. It may, for example, be used wholly or partly during the production of powdery mineral binders, including production in the cement works themselves before, during and/or after grinding, or during the preparation of dry and/or ready-mixed mortars or concretes. It may also be used wholly or partly during the transport of pasty or liquid mineral binders, or during their production in the works or on site, and for example, in the water and/or aggregates required for the preparation, particularly in vessels known commonly as “ready-mix plants”, of mortars, slurries or concretes, or just before the pouring thereof.

The present invention also relates, therefore, to a process for the preparation of a mineral binder, characterised in that an admixture as claimed is added in one or more operations to a powdery mineral binder chosen from the group comprising cements, raw materials for the production of cements, hydraulic limes, dry and/or ready-mixed mortars and concretes and mixtures thereof.

According to another variant, the invention relates to a process for the preparation of a mineral binder, characterised in that an admixture as claimed is added in one or more operations a) to a non-powdery mineral binder, particularly in the paste or liquid form, chosen from the group comprising mortars, slurries and concretes and/or b) to the water and/or aggregates required for the preparation of the said non-powdery mineral binder.

The general concept of the present invention is based on the combined use of a sugar or an oxidised sugar and a hydrogenated sugar for admixing with mineral binders, notably with a view to improving the plasticity and/or mechanical properties thereof.

These properties of improving the plasticity and/or mechanical characteristics may, as observed by the Applicants, also be turned to advantage in industrial sectors other than mineral binders, particularly non-food sectors such as the industries including plastics, thermosetting resins, mastics and rubbers, glues and adhesives, paints and varnishes, drilling additives or leather.

Moreover, it was found that such compositions combining 1 to 99% of a sugar or an oxidised sugar and 99 to 1% of a hydrogenated sugar had other interesting functional properties and could be used, in particular, as:

moistening agents, for example, in the tobacco, glue and adhesive or paint and varnish industries,

agents for controlling hydration or dehydration, for example, in industries including the plaster industry, as will be shown by example below, bricks and tiles, glues and adhesives, paints and varnishes, drilling additives or wood,

complexing agents, for example, in the plaster industries as will be shown by example below, or the surface treatment industries such as satin-finishing of aluminium, detergents and washing compositions,

oxygen reducing agents, for example, in the photographic industries, drilling additives or water treatment industries, particularly boiler waters or anti-corrosion additives;

decoring or embrittling agents, for example, in the foundry industry.

Depending on their uses, such compositions, which represent novel industrial products, are in the solid or liquid form.

When they are used in the liquid form, these novel compositions advantageously exhibit a dry solids content (DS) between about 30 and 85%, preferably between 40 and 80%.

In view of the remarkable potential applications of such products, the present invention also relates to a material composition, characterised in that it contains:

(A) 1 to 99%, preferably 3 to 75% and even more preferably 5 to 60% of a sugar or an oxidised sugar, and

(B) 99 to 1%, preferably 97 to 25% and even more preferably 95 to 40% of a hydrogenated sugar, these percentages being expressed in dry weight with respect to the total dry weight of sugar or oxidised sugar and hydrogenated sugar contained in the said composition.

According to a preferred variant, said composition

contains an oxidised sugar,

is liquid and has a dry solids content of about 30 to 85%, preferably 40 to 80%.

The present invention also relates to the use of such a composition not only in the mineral binder sector but also in the industries including plastics and thermosetting resins, mastics and rubbers, glues and adhesives, paints and varnishes, drilling additives, leather, tobacco, plasters, tiles and bricks, wood, surface treatments, particularly satin-finishing, detergents and washing compositions, photography, water treatment and foundries, particularly as plasticisers, moistening agents, hydration or dehydration controllers, complexing agents, oxygen reducers and/or decoring or embrittling agents.

This use may relate in particular to the plaster industry.

### MORE DETAILED DESCRIPTION

The present invention will be described in an even more detailed manner with the aid of the examples which follow and which are in no way restrictive.

In all the examples that follow, the spreading measurements (in mm) and the mechanical strength measurements (in MPa) at 17 hours, 24 hours, 48 hours, 14 days or 28 days were carried out according to the standard CEN 196-01. In these examples, the following abbreviations are used: SGO: oxidised glucose syrup (DE: 37) according to the patent EP 232.202; SMA: maltitol syrup containing, on a dry weight basis, 30% sorbitol and 45% maltitol; GSL: liquid sodium gluconate; MALP: pure crystalline maltitol MALTISORB® P200 sold by the Applicants; LYCASIN®: maltitol syrup sold by the Applicants containing, on a dry weight basis, 3% sorbitol and 52% maltitol; POLYSORB®: hydrogenated glucose syrup POLYSORB® 70/12/12 sold by the Applicants containing, on a dry weight basis, 12% sorbitol and 15% maltitol; ROCLYS®: glucose syrup ROCLYS® B 3879 with a DE of about 38 sold by the Applicants; MALTISORB®: maltitol syrup MALTISORB® 70/75 sold by the Applicants containing, on a dry weight basis, 75% maltitol and 3% sorbitol; SG: glucose syrup (DE: 42) containing, on a dry weight basis, 18% glucose and 14% maltose; SGH1: hydrogenated glucose syrup containing, on a dry weight basis, 21% sorbitol and 13% maltitol; SGH2: idem SGH1 but containing 11% sorbitol and 10% maltitol; XYLP: pure crystalline xylitol XYLISORB® sold by the Applicants; ARAP: crystalline arabitol; LACP: crystalline lactitol monohydrate; LSB: raw sodium lignosulphonates; LSP: sodium lignosulphonates without sugar; PAC: polyacrylates; TEA: triethanolamine; PTS: trisodium phosphate; BOR: borax.

### EXAMPLE 1

Reference mortars T1a and T1b are prepared by mixing 450 g of cement CPA 55 HP, said cement originating either from a first batch (“batch a”) or a second batch (“batch b”), with 1350 g of standardised sand and 225 g of water. The spreading S is measured in mm, the initial set IS and the final set FS in hours and minutes, and the mechanical strengths at 17 hours, 48 hours and 28 days, in MPa. The results obtained are as follows:

| REFERENCE MORTAR | T1a | T2b |
|---|---|---|
| SPREADING | 213.5 | 218.5 |
| INITIAL SET | 3 h 35 | 3 h 40 |
| FINAL SET | 4 h 50 | 5 h 55 |
| STRENGTH AT 17 H | 10.8 | 11.9 |
| STRENGTH AT 48 H | 27 | 26.6 |
| STRENGTH AT 28 D | 48.4 | 52.2 |

### EXAMPLE 2

Mortar T1a compositions are prepared according to EXAMPLE 1 above to which is added 0.3%, expressed in dry 5 weight/dry weight of cement, of each of the following products: SGO, GSL, ROCYLS®, MALP, MALTISORB®, LYCASIN®, SMA, POLYSORB®, XYLP, ARAP, LSB, LSP and PAC. The results obtained are given below:

| | | S 17 h | | |
|---|---|---|---|---|
| Admixture (0.3%) | S (mm) | (MPa) | S 48 h (MPa) | S 28 d (MPa) |
| SGO | 277 | 1.1 | 24 | 52.5 |
| GSL | 269.5 | 2.0 | 5 | 52.5 |
| ROCLYS ® | 221.5 | 0.4 | 16.4 | 54.5 |
| MALP | 198.5 | 8.1 | 27.3 | 52.5 |
| MALTISORB ® | 188.5 | 7.2 | 27.6 | 55 |
| LYCASIN ® | 206 | 7.7 | 27.1 | 51 |
| SMA | 196.5 | 7.4 | 27.3 | 51.5 |
| POLYSORB ® | 221.5 | 5.7 | 28.4 | 50.5 |
| XYLP | 205 | 7.9 | ND* | 56 |
| ARAP | 217 | 8.0 | ND* | 53 |
| LSB | 227.5 | 6 | 14.6 | 26.7 |
| LSP | 228.5 | 10.2 | 22.2 | 52 |
| PAC | 259.5 | 9.9 | 19.8 | 55.5 |

ND* = not determined

These results as a whole show that:

the sugars (ROCYLS®) and oxidised sugars (SGO, GSL) have an extremely strong plasticising and retarding effect. They do not make it possible to obtain sufficient early strength to permit dismantling of the formwork. They give strengths at 48 hours which are lower than the reference T1a not containing admixture (27 MPa).

The hydrogenated sugars (MALP, MALTISORB®, LYCASIN®, SMA, POLYSORB®, XYLP and ARAP) have a much weaker plasticising and retarding effect than the sugars and oxidised sugars. They make it possible to obtain sufficient early strength to permit dismantling of the formwork (S17h=5 MPa). Moreover, they confer strengths at 48 hours that are equal to or greater than those of the reference T1a not containing admixture.

The raw lignosulphonates (LSB) and lignosulphonates without sugar (LSP) have a greater plasticising effect than the hydrogenated sugars and lower than the oxidised sugars. Their performances at 17 hours and 48 hours are lower than those of the reference T1a not containing admixture.

With the exception of the product LSB, all the admixtures tested confer strengths at 28 days that are greater than that of the reference T1a not containing admixture (48.4 MPa), namely around 50 and 56 MPa.

### EXAMPLE 3

Mixtures of an oxidised sugar (GSL) and a hydrogenated sugar (MALP) are prepared, varying the weight ratio of GSL/MALP (dry/dry) from the ratio 100% % to the ratio 0%/100%. 0.3% of these various mixtures is added to mortar compositions T1a. The results obtained are given below:

| | | S 17 h | | |
|---|---|---|---|---|
| Admixture (0.3%) | S (mm) | (MPa) | S 48 h (MPa) | S 28 d (MPa) |
| GSL/MALP | 269.5 | 0 | 5 | 52.5 |
| (100/0) | | | | |
| GSL/MALP | 266 | 1.6 | 20.5 | 54.0 |
| (50/50) | | | | |
| GSL/MALP | 281 | 4.8 | 24.5 | 56.5 |
| (25/75) | | | | |
| GSL/MALP | 269 | 7.5 | 29.7 | 63.0 |
| (10/90) | | | | |
| GSL/MALP | 198.5 | 8.1 | 27.3 | 52.5 |
| (0/100) | | | | |

These results show that, for the mixtures tested, synergistic effects are witnessed both in terms of plasticity and, as a whole, mechanical strength. The mixtures having weight ratios of GSL/MALP of 25/75 and 10/90 (dry/dry) prove to be particularly advantageous admixtures since they make it possible, inter alia, to obtain strengths at 28 days greater than 56 MPa, which may exceed 60 MPa.

The same general observations were made by replacing (a) the product GSL by the oxidised sugar SGO and (b) the product MALP by the hydrogenated sugar POLYSORB®.

The Applicants observed that the synergistic effects were also obtained, whether with an addition of 0.3% or 0.15%, by combining an oxidised sugar such as the product GSL with other hydrogenated sugars such as the products XYLP (crystalline xylitol), LACP (crystalline lactitol) or MANP (crystalline mannitol).

### EXAMPLE 4

0.3% of each of the following mixtures is added to mortar compositions T1a:

MALP/PAC with a weight ratio of hydrogenated sugar/polyacrylates of 50/50 based on dry/dry;

POLYSORB®/PAC with a weight ratio of hydrogenated sugar/polyacrylates also of 50/50.

The results obtained are given below and compared with those recorded with 0.3% respectively of each of these hydrogenated sugars and polyacrylates;

| | | S 17 h | | |
|---|---|---|---|---|
| Admixture (0.3%) | S (mm) | (MPa) | S 48 h (MPa) | S 28 d (MPa) |
| MALP | 198.5 | 8.1 | 27.3 | 32.5 |
| POLYSORB ® | 221.5 | 5.7 | 28.4 | 50.5 |
| PAC | 259.5 | 9.9 | 19.8 | 55.5 |
| MALP/PAC | 224.5 | 8.2 | 17 | 40.5 |
| (50/50) | | | | |
| POLYSORB ® / | 301 | 4.8 | 20.6 | 37 |
| PAC (50/50) | | | | |

These results show that, as a whole, there is no synergistic effect between hydrogenated sugars and polycarboxylated synthetic products such as polyacrylates. On the contrary, the combinations of hydrogenated sugar and polyacrylates give rise to mechanical strengths which fall short of those that one might have anticipated in view of the respective quantities of hydrogenated sugar and polyacrylates used. Particularly surprisingly, such combinations confer particularly low strengths at 28 days on the mortar tested (of the order of 40 MPa) which are very significantly reduced compared with those observed for the products tested on their own (of the order to 50-55 MPa). The absence of synergy was verified with the use of 0.15% of such mixtures.

### EXAMPLE 5

0.3% of each of the following mixtures according to the invention is added to mortar compositions T1b:

a binary mixture of the oxidised sugar GSL and the hydrogenated sugar SMA according to the weight ratio GSL/SMA of 5/95;

a ternary mixture containing, by weight (dry/dry) 95% of a binary mixture of GSL/SMA and 5% of triethanolamine (TEA);

two ternary mixtures identical to that described above except that the TEA is replaced either by trisodium phosphate (PTS) or borax (BOR).

The results obtained are given below.

| Admixture (0.3%) | S (mm) | S 48 h (MPa) |
|---|---|---|
| GSL/SMA (5/95) | 281.5 | 23 |
| 95% GSL/SMA (5/95) + 5% TEA | 283.5 | 24.8 |
| 95% GSL/SMA (5/95) + 5% PTS | 283.5 | 26.0 |
| 95% GSL/SMA (5/95) + 5% borax | 282.5 | 24.8 |

These results show that the use of a small quantity of conventional admixture within the admixture according to the invention (5% based on dry/dry) also makes it possible to improve the plasticity and strength at 48 hours.

### EXAMPLE 6

Within the scope of this example, the effect studied is that of incorporating an admixture according to the invention in a non-hydrated cement raised to and kept at a high temperature. More specifically, the cement CPA 52.5 HP is heated for 2 hours at about 100° C. then 0.1% by weight (dry/dry) of GSL, SMA or an admixture according to the invention composed of a mixture of GSL/SMA (weight ratio of 5/95) is incorporated therein by mixing in a device of the ROBOT-COUPE type. The admixture-containing cement thus obtained is then kept for one hour at about 100° C. After cooling, a mortar is prepared from this admixture-containing cement according to the procedure of EXAMPLE 1. The results obtained are given below:

| Admixture (0.1%) | IS (h mn) | S 17 h (MPa) | S 14 d (MPa) |
|---|---|---|---|
| WITHOUT | 4 h 00 | 7.7 | 51.0 |
| GSL | 6 h 30 | 5.1 | 49.0 |
| SMA | 6 h 15 | 7.3 | 50.0 |
| GSL/SMA (5/95) | 5 h 50 | 7.5 | 54.0 |

These results show, surprisingly, that the mixture of oxidised sugar/hydrogenated sugar tested has a less retarding effect than each of the components of said mixture (GSL and SMA). This mixture also produces unexpected synergistic effects in terms of strength both as regards early strength and after 14 days. This example shows that a composition of oxidised sugar/hydrogenated sugar which is the object of the invention may also be used advantageously as an admixture even in a cement.

### EXAMPLE 7

A reference mortar T1c is prepared in the same way as the mortars T1a and T1b. 0.3% of each of the following products is incorporated therein: SG, SGH1, SGH2 and mixtures SG/SGH1 and SG/SGH2, varying the weight ratios between sugar and hydrogenated sugar. The results obtained are given below.

| Admixture (0.3%) | S (mm) | IS (h mn) | FS (h mn) | S 24 h (MPa) |
|---|---|---|---|---|
| WITHOUT | 205 | 2 h 40 | 5 h 25 | 14.7 |
| SG | 234 | 11 h 40 | 17 h 40 | 0.5 |
| SGH1 | 245 | 6 h 20 | 9 h 35 | 11.9 |
| SG/SGH1 (50/50) | 251.5 | 7 h 45 | 13 h 15 | 7.4 |
| SG/SGH1 (25/75) | 250 | 6 h 00 | 10 h 00 | 10.9 |
| SGH2 | 251.5 | 6 h 30 | 8 h 30 | 11.5 |
| SG/SGH2 (50/50) | 276.5 | 7 h 15 | 15 h 00 | 6.1 |
| SG/SGH2 (25/75) | 267 | 7 h 40 | 9 h 55 | 8.8 |

These results show that the sugar SG has a plasticising effect but an extremely strong retarding effect. It does not make it possible to obtain an early strength sufficient to allow dismantling of formwork. The hydrogenated sugars SGH1 and SGH2 have a much weaker retarding effect. They make it possible to obtain early strengths that are sufficient for dismantling of formwork (11-12 MPa). Remarkably, the sugar/hydrogenated sugar mixtures tested bring about synergistic effects both in terms of plasticity and mechanical strength.

### EXAMPLE 8

A composition X according to the invention having a dry solids content of about 50% and containing, based on dry product, 75% sodium gluconate and 25% maltitol MALTISORB® P200 is used in the preparation of a manual plaster according to the following formulation:

| | kg based on |
|---|---|
| | dry product |
| plaster (75% semi-hydrated - 25% | 998.8 |
| overcured) | |
| thickening starch TEXALYS ® V213 | 0.4 |
| lime | 0.3 |
| composition X according to the invention | 0.5 |

A reference plaster formulation is prepared in the same way except that no composition x was introduced.

It appears that composition X makes it possible:

1) to retard sufficiently the setting of the plaster to allow easy placing, and

2) to obtain, after drying of the plaster, a coating with a smooth appearance without shrinkage or crazing.

This example shows that the compositions according to the invention may be used advantageously in the plaster industry due to their good complexing properties and dehydration-controlling properties.

We claim:

1. An admixture for mineral binders, comprising a composition containing:
(A) 1 to 99% of a sugar or an oxidised sugar, and
(B) 99 to 1% of a hydrogenated sugar,
these percentages being expressed in dry weight with respect to the total dry weight of sugar or oxidised sugar and hydrogenated sugar contained in the said composition.

2. An admixture according to claim 1, wherein the composition contains
(A) 3 to 75%of the sugar or an oxidised sugar, and
(B) 97 to 25 of the hydrogenated sugar.

3. An admixture according to claim 2, wherein the composition contains
(A) 5 to 60% of the sugar or an oxidised sugar, and
(B) 95 to 40% of the hydrogenated sugar.

4. An admixture according to claim 1, wherein
the sugar is chosen from the group consisting of starch hydrolysates, and/or
the oxidised sugar is chosen from the group consisting of gluconic acid, glucaric acid, xylonic acid, arabinonic acid, lactobionic acid, maltobionic acid, erythorbic acid, oxidised starch hydrolysates, salts thereof and any mixtures of at least any two of said products, and/or
the hydrogenated sugar contained in the said composition is chosen from the group consisting of sorbitol, mannitol, xylitol, arabitol, maltitol, lactitol, maltotriitol, hydrogenated starch hydrolysates and any mixtures of at least any two of said products.

5. An admixture according to claim 1, also comprising at least one product chosen from the group consisting of phosphates, sulphates, borates, amines, particularly triethanolamine, calcium salts, derivatives of sulphonated melamines or sulphonated naphthalenes, polyacrylates, polyols other than hydrogenated sugars, particularly glycerol and glycols, lignosulphonates and any mixtures of at least any two of the said products.

6. An admixture according to claim 5, comprising a product chosen from the group consisting of phosphates, borates, amines and mixtures thereof, the weight ratio between the said product and the composition, expressed in dry weight of product with respect to the dry weight of the composition, being between 0.1 and 20%.

7. An admixture according to claim 6, wherein the weight ratio is between 0.5 and 15%.

8. An admixture according to claim 7, wherein the weight ratio is between 1 and 10%.

9. A mineral binder, containing 0.001 to 5% of an admixture according to claim 1, this percentage being expressed in dry weight of the said admixture with respect to the total dry weight of raw material(s) for cement before grinding, cement, and/or lime contained in the said mineral binder.

10. A mineral binder according to claim 9, said binder being chosen from the group consisting of cements, raw materials for the production of cements, hydraulic limes and mixtures thereof, and containing 0.001 to 1.3% of an admixture according to claim 1.

11. A mineral binder according to claim 10, containing 0.005 to 0.7% of the admixture.

12. A mineral binder according to claim 11, containing 0.01 to 0.5% of the admixture.

13. A mineral binder according to claim 9, said binder being chosen from liquid, pasty or solid mortars, slurries and concretes, and containing 0.005 to 5% of an admixture according to claim 1.

14. A mineral binder according to claim 13, containing 0.01 to 2% of the admixture.

15. A mineral binder according to claim 14, containing 0.02 to 1% of the admixture.

16. A process for the preparation of a mineral binder, wherein an admixture according to claim 1 is added in one or more operations to a powdery mineral binder chosen from the group consisting of cements, raw materials for the production of cements, hydraulic limes, dry and/or ready-mixed mortars and concretes and mixtures thereof.

17. A process for the preparation of a mineral binder, wherein an admixture according to claim 1 is added in one or more operations a) to a non-powdery mineral binder, particularly in the paste or liquid form, chosen from the group consisting of mortars, slurries and concretes and/or b) to the water and/or aggregates required for the preparation of the said non-powdery mineral binder.

18. A process for improving the plasticity and/or the mechanical properties of mineral binders by admixing a sugar or an oxidised sugar and a hydrogenated sugar with mineral binders.

19. A material composition, containing
(A) 1 to 99% of a sugar or an oxidised sugar, and
(B) 99 to 1% of a hydrogenated sugar,
these percentages being expressed in dry weight with respect to the total dry weight of sugar or oxidised sugar and hydrogenated sugar contained in the said composition.

20. A material composition according to claim 19, containing
(A) 3 to 75% of the sugar or the oxidised sugar, and
(B) 97 to 25% of the hydrogenated sugar.

21. A material composition according to claim 20, containing :
(A) 5 to 60% of the sugar or the oxidised sugar, and
(B) 95 to 40% of the hydrogenated sugar.

22. A composition according to claim 19, containing an oxidised sugar, being liquid and having a dry solids content of 30 to 85%.

23. A composition according to claim 22, having a dry solids content of 40 to 80%.
